(19) United States
(12) Patent Application Publication
(10) Pub. No.: US 2021/0070897 A1
(43) Pub. Date: Mar. 11, 2021

(54) HIGH SOLIDS, SURFACTANT-FREE FLUOROPOLYMER

(71) Applicant: Arkema Inc., King of Prussia, PA (US)

(72) Inventors: James T. GOLDBACH, Paoli, PA (US); John STULIGROSS, Downingtown, PA (US); Patrick KAPPLER, Ecully (FR)

(21) Appl. No.: 16/981,449

(22) PCT Filed: Mar. 15, 2019
(86) PCT No.: PCT/US2019/022385

§ 371 Date: Sep. 16, 2020

Related U.S. Application Data
(60) Provisional application No. 62/643,826, filed on Mar. 16, 2018.

(51) Int. Cl. C08F 14/22; C08J 9/28

(52) U.S. Cl. CPC C08F 14/22; C08J 2201/05; C08J 2327/16; C08J 9/28

(57) ABSTRACT

The invention relates to a low coagulum fluoropolymer latex containing little or no surfactant, and having a high fluoropolymer solids content. The polymerization is run at temperatures somewhat greater than typically used. The latex can be dried into a solid resin, in which little or no surfactant is present, without using an ion exchange, washing, or other added unit operation. The invention also relates to the process for forming the high solids, latex, using little or no surfactant.

### FIELD OF THE INVENTION

The invention relates to a low coagulum fluoropolymer latex containing little or no surfactant, and having a high fluoropolymer solids content. The polymerization is run at temperatures somewhat greater than typically used. The latex can be dried into a solid resin, in which little or no surfactant is present, without using an ion exchange, washing, or other added unit operation. The invention also relates to the process for forming the high solids, latex, using little or no surfactant.

### BACKGROUND OF THE INVENTION

Emulsion polymerization is a preferred method for forming fluoropolymers, producing fluoropolymer particles with an average particle size in the range of 20 nm to 1000 nm, and a latex having a low viscosity of generally less than 10 cP, that is shear and storage stable and can be easily conveyed by pumping or other typical liquid process techniques.

It is generally understood, in the art of commercial fluoropolymers that a stabilizing additive must be used in order to obtain a stable dispersion of polymer particles in the liquid (aqueous) phase. Common additives, known as surfactants or emulsifiers, include ionic amphiphiles such as sodium lauryl sulfate (SLS), hexadecyl trimethylammonium bromide (CTAB); and non-ionic amphiphiles such as octaethylene glycol monododecyl ether, and polyethylene glycol octylphenyl ethers (such as TRITON X-100). These compounds act to stabilize the interface of the (fluoro)polymer particles and the water phase thereby reducing the strength of particle-particle interactions and gross, premature coagulation of the solid from the liquid phase. Emulsions made with these types of surfactants often show increased stability against coagulation due to mechanical shearing, and it is often possible to increase their solids concentration while maintaining very low viscosity, both of which allow for efficient and cost-effective commercial production of the fluoropolymer resins as well as their direct use in applications where a low-viscosity, aqueous dispersion of solid is required, such as the base material in high-performance architectural coatings.

Conversely, while these surfactants improve desirable properties of the fluoropolymer latexes, they have the undesired effect of interfering with the free-radical polymerization reaction by chain-transfer. This interference manifests itself as a reduction of kinetics of polymerization, reducing production throughput, as well as possibly incorporating some of the surfactant structure into the fluoro(co)polymer itself, which in turn can alter the physical properties of the final material in an undesirable fashion, such as imparting a yellow or brown color.

To combat these issues, those skilled in the art have widely utilized (per)fluorinated surfactants for fluoromonomer polymerizations that do not interfere with or participate in the fluoromonomer polymerization reaction. While this approach has been extremely effective, there have arisen significant concerns regarding the biological and environmental persistence these fluorosurfactants, of as well as their toxicity. Therefore, it is highly desirable to discontinue their use.

Stable fluoro-surfactant-free fluoropolymers have been produced, as described for example in U.S. Pat. Nos. 8,080,621; 8,124,699; 8,697,822; and 9,068,071. While solving the toxicity issues, the fluoropolymers produced with non-fluorinated surfactant can oxidize under heat aging, causing an undesired yellowing of the fluoropolymer.

Residual surfactants also reduce and interfere with the ability to cross-link a fluoropolymer by irradiation, as the residual surfactants preferentially absorb the radiation and can react with formed polymer backbone radicals, generating non-cross-linked sites. This is particularly important when a foamed product is desired, as cross-linking is known to impart greater structural integrity to the finished foam. Additionally, surfactants add to the cost of producing the fluoropolymer, and reducing or eliminating surfactants provides a more cost-effective product.

Efforts have been made to reduce or eliminate surfactants from fluoropolymer emulsion polymerization, all with shortcomings.

U.S. Pat. No. 5,453,477 requires a redox-type initiation system and does not disclose the total latex solids or melt color stability of the final material.

U.S. Pat. No. 3,714,137 requires the addition of an acid, a pH of 4 to 6 and has no mention of achievable solids content in the latex. In fact, they provide an example where latex is continuously removed from the reactor and replaced with water, a process that is not optimal for commercial production of high-solids latex.

WO 02/088207 describes an emulsifier-free emulsion process for making fluoropolymers in which inorganic, ionic initiators are used. The particle size is large, resulting in a short shelf-life, and a fairly unstable emulsion, while the solids level is low. Low solids and low stability are not desired properties.

Fluoropolymer have been made without surfactants, as described in U.S. Pat. No. 7,091,288, by polymerizing the monomers in supercritical CO₂. This does not result in an emulsion, and requires very costly, special equipment capable of operating at extremely-high pressures.

Prior art also exists in which surfactants are heavily washed following coagulation, in order to remove much of the surfactant. This adds complications with additional unit operations, and no matter how much washing occurs, the level of surfactant can never reach zero.

Surprisingly, it has now been found that a low coagulum, low viscosity, high-solids, emulsifier-free aqueous fluoropolymer emulsion can be produced when the polymerization temperature of the reaction is increased modestly from about 80° C. to about 89° C. or greater, or from about 89 to 115 C, preferably increased to between 90 to 125° C., more preferably between 90 and 100° C. in the presence of an ionic initiator. This temperature increase permits the production of latexes with solids greater than 26 wt % or even greater than 30 wt % and little or no coagulum (less than or equal to 11 wt %), while running the same emulsion process at less than 89° C. produces a solids level of less than 26%, and a relatively high level of coagulum. The aqueous fluoropolymer emulsion of the invention can be storage stable.

A further advantage is that melt-processed plaques of the fluoropolymer produced exhibit improved thermal-color stability vs. relevant controls, a critical factor for many fluoro(co)polymer applications where melt-processing techniques such as extrusion and injection molding are used to generate final parts and products.

### SUMMARY OF THE INVENTION

In a first aspect of the invention, the invention relates to a low coagulum fluoropolymer emulsion composition comprising at least 24 weight percent of fluoropolymer, and less than 0.01 weight percent of surfactant. In other aspects, the level of fluoropolymer solids could be greater than 26 weight percent of fluoropolymer, and greater than 30 weight percent of the composition. The level of fluoropolymer solids is preferably from 26 to 40 weight percent, and more preferably from 28 to 35 weight percent.

The low coagulum fluoropolymer emulsion composition of the first aspect is a homopolymer or copolymer having at least 70 weight percent of vinylidene fluoride monomer units.

The low coagulum fluoropolymer emulsion composition of the first and second aspects could further comprise from 100 ppm to 10,000 ppm of one or more ionic or ionizable initiators, with at least one persulfate initiator being preferred in the initiator composition.

The low coagulum fluoropolymer emulsion composition of any or the preceding aspects could optionally also contain dyes, colorants, impact modifiers, antioxidants, flame-retardants, ultraviolet stabilizers, flow aids, conductive additives such as metals, carbon black and carbon nanotubes, defoamers, crosslinkers, waxes, solvents, plasticizers, and anti-static agents.

In another aspect, the low coagulum fluoropolymer emulsion composition of any of the preceding aspects has a level of surfactant of zero.

A further aspect is a process for forming a low coagulum fluoropolymer emulsion, comprising the steps of:
a) charging a reaction mixture to a reactor, said reaction mixture comprising one or more fluoromonomers, less than 0.01 weight percent of surfactant, based on the weight of fluoromonomers, with stirring,
b) heating the reaction mixture to a temperature of at least 89° C., and adding one or more ionic initiators,
c) continuous feeding additional monomer and initiator, and less than 0.01 weight percent of surfactant, based on the level of total monomer until polymerization is completed.

In a preferred process no surfactant is added during the polymerization.

Another aspect of the invention relates to a foam produced from the fluoropolymer composition of any or the preceding aspects.

### BRIEF DESCRIPTION OF THE DRAWINGS

FIG. 1. Representative plaque color results for a commercial control PVDF (Kynar 740FSF) and three inventive examples.

### DETAILED DESCRIPTION OF THE INVENTION

All references listed in this application are incorporated herein by reference. All percentages in a composition are weight percent, unless otherwise indicated, and all molecular weights are given as weight average molecular weight as determined by a GPC using PMMA as the standard, unless stated otherwise.

The term “polymer” is used to mean both homopolymers, copolymers and terpolymers (three or more monomer units), unless otherwise stated. Any copolymer or terpolymer can be random, blocky, or gradient, and the polymer can be linear, branched, star-shaped, comb-shaped or of any other morphology.

The term “storage stable” in reference to fluoropolymer latex compositions of the invention, means a latex that can be poured and pumped with little (less than 5% by weight of the polymer solids, preferably less than 3% by wt and even more preferably less than 1.5% by weight of the polymer solids) or no formation of coagulum, or if formed can be re-dispersed with gentle agitation, coagulum being defined as a material that will not pass through a 100 mesh screen. Such coagula include hard particles and wet masses of material (sometimes referred to as “blobs”). The low coagulum fluoropolymer latex of the invention is one that will preferably not visually settle after three months of storage, or if slight settling occurs, it can be redispersed with gentle agitation. In this case, gentile agitation includes reciprocal inversion of the sealed latex container with frequency of one inversion per second, or direct mechanical agitation. In terms of mechanical agitation, a low-shear-type agitator setup (not rotor/stator, high-shear type) utilizing a 45-degree pitched blade, radial flow impeller coupled to a variable-speed motor, with gap of at least 1 cm between the wall of the container and the tip of the agitator blade should be employed at a rotational rate of no more than 200 rpm to re-homogenize settled latex. The minimum rotational rate that gives visual indication of the re-incorporation of the water and latex phases should be used. If coagulum forms on settling or after the aforementioned re-dispersion operation, the material would be considered as unstable.

For purposes of this invention, low viscosity means the latex has a viscosity of 10 cP or less as measured at 25 C using Brookfield DV3T variable speed rheometer and CPA-40Z spindle.

### Fluoropolymer

The fluoropolymers of the invention include, but are not limited to polymers containing at least 50 weight percent of one or more fluoromonomers. The term “fluoromonomer” as used according to the invention means a fluorinated and olefinically unsaturated monomer capable of undergoing free radical polymerization reaction. Suitable exemplary fluoromonomers for use according to the invention include, but are not limited to, vinylidene fluoride (VDF), tetrafluoroethylene (TFE), trifluoroethylene (TrFE), chlorotrifluoroethylene (CTFE), hexafluoropropene (HFP), vinyl fluoride (VF), hexafluoroisobutylene (HFIB), perfluorobutylethylene (PFBE), pentafluoropropene, 3,3,3-trifluoro-1-propene, 2-trifluoromethyl-3,3,3-trifluoropropene, 1,1-dichloro-1,1-difluoroethylene, 1,2-dichloro-1,2-difluorethylene, 1,1,1,-trifluoropropene, 1,3,3,3-tetrafluoropropene, 2,3,3,3-tetrafluoropropene, 1-chloro-3,3,3-trifluoropropene, fluorinated or perfluorinated vinyl ethers including perfluoromethyl ether (PMVE), perfluoroethylvinyl ether (PEVE), perfluoropropylvinyl ether (PPVE), perfluorobutylvinyl ether (PBVE), longer chain perfluorinated vinyl ethers, fluorinated dioxoles, partially- or per-fluorinated alpha olefins of C4 and higher, partially- or per-fluorinated cyclic alkenes of C3 and higher, and combinations thereof. Fluoropolymers produced in the practice of the present invention include the products of polymerization of the fluoromonomers listed above, for example, the homopolymer made by polymerizing vinylidene fluoride (VDF) by itself.

Fluoro-terpolymers are also contemplated, including terpolymers such as those having tetrafluoroethylene, hexafluoropropene and vinylidene fluoride monomer units. Most preferably the fluoropolymer is a polyvinylidene fluoride (PVDF). The invention will be exemplified in terms of PVDF, but one of ordinary skill in the art will recognize that other fluoropolymers could be represented where the term PVDF is exemplified.

The polyvinylidene fluoride (PVDF) of the invention includes PVDF homopolymer, copolymer or polymer alloy. Polyvinylidene fluoride polymers of the invention include the homopolymer made by polymerizing vinylidene fluoride (VDF), and copolymers, terpolymers and higher polymers of vinylidene fluoride, where the vinylidene fluoride units comprise greater than 51 percent by weight, preferably 70 percent of the total weight of all the monomer units in the polymer, and more preferably, comprise greater than 75 percent of the total weight of the monomer units. Copolymers, terpolymers and higher polymers (generally referred to herein as “copolymers”) of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. Preferred copolymers or terpolymers are formed with vinyl fluoride, trifluoroethene, tetrafluoroethene (TFE), and hexafluoropropene (HFP).

Preferred copolymers include those comprising from about 55 to about 99 weight percent VDF, and correspondingly from about 1 to about 45 weight percent HFP, and preferably a level of HFP of 2 to 30 weight percent; copolymers of VDF and CTFE; terpolymers of VDF/HFP/TFE, copolymers of VDF and TFE; and terpolymers of VDF/TFE/perfluorovinyl ethers.

In one embodiment of the invention, it is preferred that all monomer units be fluoromonomers, however, copolymer of fluoromonomers with non-fluoromonomers are also contemplated by the invention. In the case of a copolymer containing non-fluoromonomers, at least 60 percent by weight of the monomer units are fluoromonomers, preferably at least 70 weight percent, more preferably at least 80 weight percent, and most preferably at least 90 weight percent are fluoromonomers. Useful comonomers include, but are not limited to, ethylene, propylene, styrenics, acrylates, methacrylates, vinyl esters, vinyl ethers, non-fluorine-containing halogenated ethylenes, vinyl pyridines, and N-vinyl linear and cyclic amides.

### Surfactant

While the preferred embodiment of the invention is for no surfactant to be used anywhere in the polymerization process, it is possible to use very low levels of surfactant, below 0.01 weight percent, and preferably below 0.004 weight percent, based on the total monomer. If a very low level of surfactant is used, it can be either a fluoro-surfactant or non-fluorosurfactant, as known in the art. Preferably a non-fluorosurfactant is used.

### Initiator

Ionizable initiators, such as peroxides, are preferably used to initiate the polymerization of the invention. These compounds are added at a level sufficient to maintain a sufficient polymerization rate, typically from 100 ppm to 10,000 ppm versus total monomer, preferably from 250 ppm 2,000 ppm, and most preferably from 500 ppm to 1,500 ppm. The initiator can be fed entirely to the initial feed, but is generally delay fed during the course of the reaction. Useful ionic initiators include, but are not limited to inorganic peroxides such as: persulfates, such as ammonium persulfate, potassium persulfate, sodium persulfate; perphosphates, and permanganates. Other ionic initiators known in the art, including organic initiators with acid end groups are also contemplated for use in the invention such as succinic acid peroxide. Blends of ionizable inorganic peroxides with other inorganic or organic peroxides are contemplated as well. Potassium persulfate is an especially preferred initiator.

It is envisioned that ionic-group-containing organic peroxides such as succinic acid peroxide or hydroxyl radical-generating initiators such as hydrogen peroxide would work in a similar fashion. As is commonly practiced in the art, these types of initiators can be used in conjunction with reducing agents in a ‘redox’ type initiation system in which a reducing agent is introduced and a third catalytic component may also be added.

### Reaction Conditions

The polymerization of the surfactant-free fluoropolymer emulsion of the invention is conducted at a temperature that is slightly elevated, compared to typical fluoropolymer emulsion polymerizations. In the polymerization of vinylidene fluoride polymers and copolymers, the reaction temperature is at least 89 C, preferably between 89° C. and 140° C., or between 89° C. and 125° C., preferably 89 and 115° C., preferably between 90 and 125° C., and more preferably between 90 and 100° C. In a preferred embodiment, this reaction temperature is held constant (+/−1° C.) during the course of the polymerization.

The polymerization can be run in a batch mode, or preferably at least some of the monomer and initiator is in an initial, with a portion of the monomer and/or initiator delay fed over the course of the polymerization.

### Other Additives

The fluoropolymer composition of the invention may also include typical additives, including, but not limited to, dyes; colorants; impact modifiers; antioxidants; flame-retardants; ultraviolet stabilizers; flow aids; conductive additives such as metals, carbon black and carbon nanotubes; defoamers; crosslinkers; waxes; solvents; plasticizers; and anti-static agents. Other additives that provide whitening could also be added to the fluoropolymer composition, including, but not limited to metal oxide fillers, such as zinc oxide; phosphate or phosphite stabilizers; and phenolic stabilizers.

### Properties

Particle size of the produced emulsions is somewhat larger than surfactant-containing systems, however, the general range of particle sizes observed was <400 nm and even <300 nm where surfactant-containing fluoropolymer emulsion particle sizes are often <250 nm.

The solids level in the stable emulsion produced in the invention is greater than 24 weight percent, preferably greater than 26 weight percent, more preferably greater than 28 weight percent, more preferably greater than 30 weight percent, and even more preferably greater than 35 weight percent. Weight percent solids of greater than 40 weight percent and even greater than 50 weight percent are contemplated. A preferred solids range is from 26 to 40 weight percent solids, and more preferably from 28 to 35 weight percent.

The shelf-life of emulsifier-free latexes of the current invention are very good, retaining their fluidity and original viscosity (no more than a 10% change, preferable less than a 5% change in Brookfield viscosity) after greater-than three months of storage with very little settling and no observable coagulum formation meaning that the latexes are storage stable for at least 3 months or greater. In addition, the latexes are stable to typical fluid-transfer techniques including discharge into storage containers, pouring, agitation as described earlier for re-dispersion of slightly-settled latex and mechanical pumping such as through a diaphragm-type recriprocating pump (Warren-Rupp, Inc. “Sandpiper” model S1F non-metallic) operating at 50% of capacity.

The molecular weight of the fluoropolymer formed by the invention depends primarily on the level of chain transfer agents added during the fluoromonomer emulsion polymerization process. The molecular weight of the fluoropolymer is similar to that of fluoropolymer produced at more typical lower polymerization temperatures in the 70 to 80° C. range. Molecular weights generally range from 50,000 to 600,000 g/mol. Molecular weight are related to the melt viscosity of the material as realized by those skilled in the art. Melt viscosities of the materials of the current invention are typical of those known in the industry as measured by capillary rheometry @ 232C, taking the viscosity value (in units of kilopoise, kP) at 100 s⁻¹ shear. For the current invention, melt viscosities measured range from 0.1 kP to 60 kP. The particular melt viscosity required is dependent on the nature of the application for the material, for example, standard melt extrusion operations perform best using materials with melt viscosities from 5.0 to 25 kP, though other processing methods and product application may require higher or lower melt viscosity materials to be used. In those cases, melt viscosity is adjusted by increasing or decreasing the quantity of chain-transfer agent in the fluoromonomer polymerization. Additionally, the number of ‘reverse units’ when using VDF is slightly higher, than PVDF polymerized at lower temperatures by ˜0.1 to 0.2% (˜5.0% of total vs. 4.8% for material made at 83° C., for example) as measured by ¹⁹F nuclear magnetic resonance spectroscopy (NMR) following the procedure of Pianca, M., et. al., POLYMER, 1987, Vol 28, p 224-230.

Plaques formed from the fluoropolymer of the invention show little or no discoloration in heat aging studies as measured using ‘Yellowness index’ (YI). YI is measured via the method described in standard test method, ASTM E313-15. For the fluoropolymers of the invention, the yellowing index is preferably less than 15, preferably less than 12, more preferably less than 11 after 10 minutes at 230 C.

For the present invention the latex viscosity is typically from 1.0 cP to 10 cP, preferably from 1.0 to 7.0 P as measured at 25 C using Brookfield DV3T variable speed rheometer and CPA-40Z spindle.

### Uses

The surfactant-free fluoropolymer emulsions of the invention are useful in any applications that surfactant-containing fluoropolymer emulsions are useful. Due to the lack of surfactant, fluoropolymers of the present invention are especially useful in applications involving heat aging, since there is no surfactant to oxidize to produce coloration and applications where radiation is applied to the material to facilitate cross-linking, particularly useful for materials to be applied to a foaming process.

### EXAMPLES

### General Procedure 1—Latex Synthesis in 7.5 L Reactor:

The procedure(s) below is written using polyvinylidene fluoride as the model polymer system. One of ordinary skill in the art could use the examples below, and teachings of the application to extend the invention to other fluoropolymer systems. Table 1 shows reaction parameters for Examples 1-16.

A 7.5 L-volume autoclave equipped with circulating jacket and mechanical agitation is charged with deionized water. This water charge is deoxygenated by pressurization of the reactor to 60 psig with ultra-pure nitrogen, holding at that pressure for 5 min with agitation, then venting to 0 psig. This cycle is repeated an additional 2 times. At that point the chain transfer agent (CTA) is admitted to the reactor. The reaction mixture temperature is then increased to the desired value greater than 89° C. and preferably 90° C. to 125° C., and most preferably equal to or greater than 95° C. and less than 110° C. Once the desired temperature has stabilized, vinylidene fluoride (VDF) is admitted to 650 psi and agitation is started at the target rate. The reaction is commenced by admission of initiator solution initial charge, followed by a slow-feed of initiator solution to a reaction rate of no more than 1800 g/hr monomer consumption, to maintain the reaction pressure and temperature with a target of a total reaction time of 120 min to 240 min and target latex solids of greater than 25% by weight. VDF gas (and/or comonomer) is optionally admitted via high-pressure syringe or reciprocating pump to maintain the 650 psi reaction pressure. Upon reaching desired calculated latex solids, monomer admission is stopped and the remaining monomer is allowed to continue to react for 10 min with concurrent pressure decrease. Following that time, the agitation is halted, reactor cooled to room temperature and vented. Product latex is discharged from the reactor through a bottom-drain and is flowed through a 100 mesh screen to capture any non-fluid components (coagulum). Latex solids is measured in duplicate using a moisture analyzer apparatus such as Mettler-Toledo model HX204, and average value reported. Percent coagulum is determined gravimetrically by difference in mass of the mesh screen before and after collection of coagulum.

### General Procedure 2—Latex Synthesis in 302.8 L Reactor

A 302.8 L-volume autoclave equipped with circulating jacket and mechanical agitation is charged with deionized water. This water charge is deoxygenated by heating to 100 C with reactor vent open to atmosphere for 30 min. The reactor contents are then cooled to the desired reaction temperature, greater than 89 C and preferably 90 C to 125 C, and most preferably equal to or greater than 95 C and less than 110 C, then chain transfer agent (CTA) is admitted to the reactor. Once the desired temperature has stabilized, vinylidene fluoride (VDF) is admitted to 650 psi and agitation is started. The reaction is commenced by admission of initiator solution initial charge, followed by a slow-feed of initiator solution to a reaction rate of no more than 54.5 kg/hr monomer consumption, to maintain the reaction pressure and temperature with a target of a total reaction time of 150 min to 240 min and total latex solids of 30 wt. % or greater. VDF gas (and/or comonomer) is optionally admitted via high-pressure syringe or reciprocating pump to maintain the 650 psi reaction pressure. Upon reaching the desired latex solids monomer admission is stopped and the remaining monomer is allowed to continue to react for 20 min with concomitant pressure decrease. Following that time, the agitation is halted, reactor contents cooled to room temperature and residual monomer gases vented. Product latex is discharged from the reactor through a bottom-drain. During discharge, latex is passed through a 100 mesh screen. Any material retained on the screen is weighed and reported as wet coagulum.

Table 1 shows the Surfactant-free fluoropolymer latex reaction components, quantities and conditions. Each run constitutes a single batch as described in ‘General Procedure 1 or 2’ with the recipe and process parameters as noted. (*Plu31R1=PLURONIC 31R1) (**KPS=potassium persulfate) (1 Coagul is Coagulum Recovered=product produced that would not pass through a 100 mesh screen over total monomer. The “Coagulum Recovered” is expressed as % of total monomers added to the batch.)

TABLE 1

| | | | | | | | | | | Melt |
|---|---|---|---|---|---|---|---|---|---|---|
| | Reactor | Rxn | DI | | VDF | HFP | | Latex | | Viscosity |
| | Volume | Temp. | Water | Stabilizer | (kg | (kg | KPS** | Solids | Coagul¹ | (kP @ 232 C., |
| Ex. # | (L) | (C.) | (kg) | (g) * | total) | total) | (g) | (wt %) | (%) | 100 s⁻¹) |
| 1 | 7.5 | 83 | 4.0 | Plu31R1 | 2.55 | 0.0 | 3.92 | 32.7 | 2.2 | 27.6 |
| Control | | | | (3.0) | | | | | | |
| 2 | 302.8 | 83 | 158.3 | Plu31R1 | 79.6 | 0.0 | 49.6 | 31.2 | 0.20 | 24.8 |
| Control | | | | (66.0) | | | | | | |
| 3 | 7.5 | 83 | 4.0 | NONE | 2.44 | 0.0 | 2.59 | 26.9 | 54.2 | 22.7 |
| Control | | | | | | | | | | |
| 4 | 7.5 | 83 | 4.0 | NONE | 2.11 | 0.0 | 2.28 | 25.7 | 71.5 | 21.8 |
| Control | | | | | | | | | | |
| 5 | 7.5 | 89 | 4.0 | NONE | 2.50 | 0.0 | 2.37 | 27.3 | 9.0 | 22.1 |
| 6 | 7.5 | 95 | 4.0 | NONE | 2.55 | 0.0 | 1.73 | 32.7 | 7.7 | 37.4 |
| 7 | 7.5 | 95 | 4.0 | NONE | 2.40 | 0.0 | 3.04 | 31.2 | 2.4 | 6.71 |
| 8 | 7.5 | 115 | 4.0 | NONE | 2.50 | 0.0 | 2.90 | 30.7 | 11.0 | 10.2 |
| 9 | 7.5 | 95 | 3.50 | NONE | 1.80 | 0.183 | 3.02 | 35.0 | 4.5 | n/d |
| 10 | 302.8 | 95 | 184.5 | NONE | 92.8 | 0.0 | 96.2 | 31.40 | 0.98 | 5.16 |
| 11 | 302.8 | 95 | 171.3 | NONE | 73.1 | 4.08 | 39.5 | 29.71 | 0.19 | 24.7 |
| 12 | 302.8 | 95 | 157.7 | NONE | 77.3 | 0.0 | 48.0 | 30.26 | 1.8 | 12.0 |
| 13 | 302.8 | 95 | 158.0 | NONE | 77.3 | 0.0 | 49.1 | 30.47 | 0.6 | 11.9 |
| 14 | 302.8 | 95 | 157.7 | NONE | 77.3 | 0.0 | 56.2 | 30.65 | 0.6 | 10.3 |
| 15 | 302.8 | 95 | 157.7 | NONE | 77.3 | 0.0 | 59.0 | 30.50 | 1.8 | 8.20 |
| 16 | 302.8 | 95 | 157.7 | NONE | 77.3 | 0.0 | 73.7 | 30.28 | 0.3 | 2.30 |

Examples 3 and 4 (control samples) were observed to be pastes (i.e. high viscosity greater than 1000).

The data in table 1 shows that running the reaction at 83 C without surfactant (examples 3 and 4) results in unacceptable excessive coagulum—greater than 50% by weight of the monomers. In control examples 3 and 4, the solids were less than 27% and the coagulum was over 50%. Surprisingly, raising the temperature to 89 C (Example 5) unexpectedly resulted in at least 6 times less coagulum then in the control examples 3 and 4 while maintaining high solid (over 27 wt %). Likewise, Examples 6 through 16 show high solids and low coagulum by using a temperature of 89 C or greater. High solids content of at least 26% or greater in the latex was achieved without surfactant and with low levels of coagulum. This finding was surprising because conventional wisdom dictates that, in order to maintain a stable latex, surfactant is needed so that the polymer particles in the emulsion will not coagulate. Compare example 1 and 2 where the presence of surfactant stabilized the latexes to examples 3 and 4 where without the surfactant the latex had excessive coagulum. In examples 6 through 16 a high solids and low coagulum was achieved by using a temperature of 89 or greater.

### Color Stability

Plaques formed from the fluoropolymer of the invention show little or no discoloration in heat aging studies. Heat aging is conducted by compression molding the solid product of the invention into a 2.0 in×0.125 in. circular disc concurrently heating the material at 230 C. The disc is periodically removed from the heat, cooled to room temperature, visually inspected and color evaluated by measurement of its ‘yellowness index’ (YI). YI is measured via the method described in standard test method, ASTM E313-15. The disc is then returned to the compression mold @ 230 C for additional time, up to 120 min. (with periodic removal and YI measurement) to determine the rate of progression of color formation due to heating.

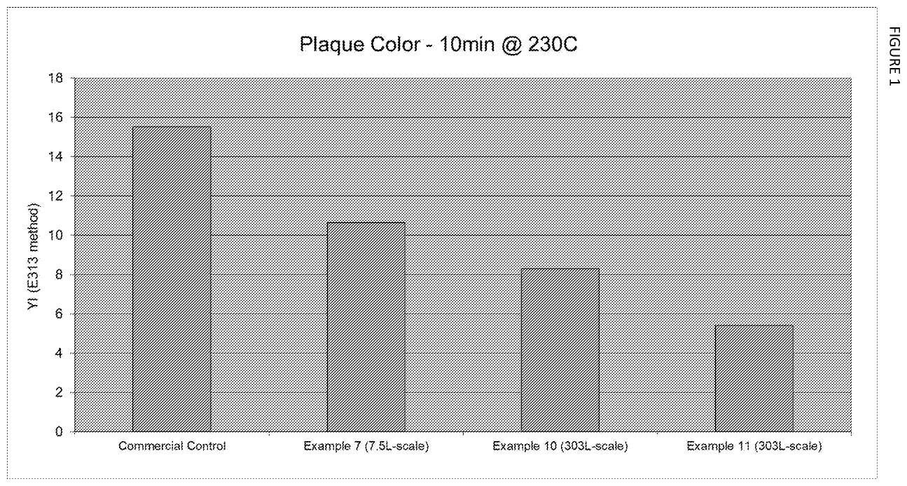

YI was measured on examples 7, 10 and 11 after 10 minutes at 230 C. The result are in table 2 and FIG. 1. For the inventive samples the yellowing index is less than 12, preferably less than 11 after 10 minutes.

| Sample | YI (yellowing index) |
|---|---|
| Control- Kynar 740FSF | 15.52 |
| Example 7 | 10.63 |
| Example 10 | 8.29 |
| Example 11 | 5.40 |

1. A low coagulum fluoropolymer emulsion composition comprising at least 26 weight percent of fluoropolymer solids in the emulsion, and less than 0.01 weight percent of surfactant based on the weight of fluoromonomers and less than 11% by weight coagulum.

2. The low coagulum fluoropolymer emulsion composition of claim 1, wherein the level of fluoropolymer solids is greater than 30 weight percent of the composition.

3. The low coagulum fluoropolymer emulsion composition of claim 1, wherein the level of fluoropolymer solids is from 26 to 40 weight percent.

4. The low coagulum fluoropolymer emulsion composition of claim 1, wherein the emulsion is storage stable.

5. The low coagulum fluoropolymer emulsion composition of claim 1, wherein said fluoropolymer comprises at least 70 weight percent of vinylidene fluoride monomer units.

6. The low coagulum fluoropolymer emulsion composition of claim 1, further comprising from 100 ppm to 10,000 ppm of one or more ionic or ionizable initiators.

7. The low coagulum fluoropolymer emulsion composition of claim 6, wherein said initiator(s) comprise at least one persulfate initiator.

8. The low coagulum fluoropolymer emulsion composition of claim 1, wherein the yellowing index is less than 11 as measured after 10 minutes at 230 C according to ASTM E313-15.

10. The low coagulum fluoropolymer emulsion composition of claim 1, wherein the level of surfactant is zero.

11. A process for forming a low coagulum fluoropolymer emulsion, comprising the steps of:
a) charging a reaction mixture to a reactor, said reaction mixture comprising one or more fluoromonomers, from 0 to less than 0.01 weight percent of surfactant, based on the weight of fluoromonomers, with stirring,
b) heating the reaction mixture to a temperature of at least 89° C., and adding one or more ionic initiators,
c) continuous feeding additional monomer and initiator, and less than 0.01 weight percent of surfactant, based on the level of total monomer, until polymerization is completed.

12. The process of claim 11, wherein no surfactant is added during the polymerization.

13. The process of claim 11, wherein said fluoropolymer comprises at least 70 weight percent of vinylidene fluoride monomer units.

14. The process of claim 11, further comprising one or more ionic or ionizable initiators, wherein from 100 ppm to 10,000 ppm of initiator is added during the process.

15. The process of claim 11, wherein said initiator(s) comprise at least one persulfate initiator.

16. The process of claim 11, wherein the temperature of reaction is from 90 C to 125 C.

17. The process of claim 11, wherein the temperature of reaction is from 90 C to 115 C.

18. A foam produced from the fluoropolymer composition of claim 1.
